(19) United States
(12) Patent Application Publication
(10) Pub. No.: US 2015/0260285 A1
(43) Pub. Date: Sep. 17, 2015

(54) Shifting Arrangement For A Motor Vehicle Gearbox, and Shifting Method

(71) Applicant: GETRAG Getriebe- und Zahnradfabrik Hermann Hagenmeyer GmbH & Cie KG, Untergruppenbach (DE)

(72) Inventor: Carsten Buender, Stuttgart (DE)

(21) Appl. No.: 14/640,783

(22) Filed: Mar. 6, 2015

(30) Foreign Application Priority Data
Mar. 14, 2014 (DE) 102014103523.2

(51) Int. Cl. F16H 63/30; F16H 61/32; F16H 63/22

(52) U.S. Cl. CPC F16H 63/30; F16H 63/22; F16H 61/32; F16H 2063/3076; F16H 2063/3079; F16H 2063/3086; F16H 2061/2838

(57) ABSTRACT

A shifting arrangement for a motor vehicle gearbox has a housing which defines a longitudinal axis. A rod is mounted axially displaceably in relation to the housing and can be coupled to a shifting clutch arrangement. A shift shaft is mounted rotatably in relation to the housing and is oriented transversely with respect to the longitudinal axis. The shift shaft being coupled to the rod by means of a driver device in such a way that the rod is displaced in a first longitudinal direction in the case of a rotation of the shift shaft in a first rotational direction. The driver device is a freewheel driver device which is configured in such a way that the rod is decoupled from the shift shaft in the case of a rotation of the shift shaft in a second rotational direction.

### CROSS-REFERENCE TO RELATED APPLICATIONS

This application claims the priority of German patent application DE 10 2014 103 523.2, filed Mar. 14, 2014.

### BACKGROUND OF THE INVENTION

The present invention relates to a shifting arrangement for a motor vehicle gearbox, having a housing which defines a longitudinal axis, having a rod which is mounted axially displaceably in relation to the housing and which can be coupled to a shifting clutch arrangement, and having a shift shaft which is mounted rotatably in relation to the housing and which is oriented transversely with respect to the longitudinal axis, the shift shaft being coupled to the rod by means of a driver device in such a way that the rod is displaced in a first longitudinal direction in the case of a rotation of the shift shaft in a first rotational direction.

Furthermore, the present invention relates to a method for actuating a shifting clutch arrangement of a motor vehicle gearbox, in particular by means of a shifting arrangement of the type denoted above.

It is known in the field of motor vehicle gearboxes to engage and disengage gear stages of a gearbox of this type in an automated manner. Motor vehicle gearboxes which are configured as multi-step gearboxes of countershaft design comprise a plurality of shifting clutches which are assigned to the respective gear stages. The shifting clutches are designed in each case to connect a shaft of the gearbox to an idler gear which is assigned to the gear stage. The shifting clutches can be configured, for example, as synchronizer shifting clutches.

Furthermore, it is known to integrate two shifting clutches of this type of adjacent idler gears into a shifting clutch arrangement which can be actuated by means of a single selector sleeve. In some cases, a shifting clutch arrangement can also comprise only one shifting clutch.

Accordingly, the engagement of a target gear stage in a motor vehicle gearbox of this type comprises first of all the step of selecting a shifting clutch arrangement of this type (selecting movement), and subsequently of axially moving a selector sleeve of a shifting clutch arrangement of this type (shifting movement).

In order to realize these two types of movements, it is known to assign a shift rod to each shifting clutch arrangement. Furthermore, a shift shaft which has a shift finger is provided here. By way of rotation of the shift shaft, the shift finger is introduced into a driver recess by one of the shift shafts (selecting movement). By way of axial movement of the shift shaft, the selected shift rod is moved axially (shifting movement). It is also known here to arrange the shift shaft transversely with respect to the shift rod. Here, a selecting operation takes place by way of an axial movement of the shift shaft, and a shifting operation takes place by way of rotation of the shift shaft.

A complicated actuator system which as a rule comprises two actuator motors is required for the rotational and the axial movement of the shift shaft.

Furthermore, it is known to use what are known as shifting drums in order to actuate shifting clutch arrangements. On their outer circumference, the shifting drums comprise shifting contours which are assigned to the shifting clutch arrangements and into which driver blocks engage which are coupled in each case to a selector sleeve. It is disadvantageous in shifting arrangements of this type that the gear stages can be engaged only in a purely sequential manner. Multiple shifting operations (shifting operations across more than two gear stages) take a relatively long time as a consequence, which is perceived as being uncomfortable. It is advantageous, in contrast, that a shifting drum requires only one drive motor.

It is known in the field of double clutch gearboxes to assign each of the component gearboxes a dedicated shifting drum with a dedicated drive. As a result of this measure, multiple shifting operations can be carried out in a considerably shorter time. However, two actuator motors which can be actuated independently of one another are once again required for the respective shifting drums.

In double clutch gearboxes which have an input shaft arrangement and two parallel output shafts, on which in each case gear stages of one and of the other component gearbox are arranged, complicated connecting elements (what are known as linkages) additionally have to be provided here which bridge the distance between a shifting drum and a drive shaft which lies at a remote location.

### SUMMARY OF THE INVENTION

Against the above background, it is an object of the invention to specify an improved shifting arrangement for a motor vehicle gearbox and an improved method for actuating a shifting clutch arrangement of a motor vehicle gearbox.

In the shifting arrangement which was mentioned at the outset, the above object is achieved by virtue of the fact that the driver device is a freewheel driver device which is configured in such a way that the rod is decoupled from the shift shaft in the case of a rotation of the shift shaft in a second rotational direction.

Furthermore, the above object is achieved by a method for actuating a shifting clutch arrangement of a motor vehicle gearbox, in particular by means of a shifting arrangement of the type according to the invention, the shifting clutch arrangement being coupled to an axially displaceable rod, it being possible for a shift shaft which is oriented transversely with respect to the rod to be driven in a first and in a second rotational direction by means of a drive motor, and a shifting cam being configured on the shift shaft, having the steps: selection of the shifting clutch arrangement by way of rotation of the shift shaft in the second rotational direction, without the rod being moved axially in the process, and shifting of the shifting clutch arrangement, by the shift shaft being rotated in the first rotational direction, the shifting cam displacing the rod in the axial direction, in order to engage a gear stage of the shifting clutch arrangement.

By way of the freewheel driver device, the shifting arrangement according to the invention makes it possible that a shift shaft is rotated in one rotational direction in order to select a shifting clutch arrangement, and is rotated in the opposite direction in order to shift the selected shifting clutch arrangement. It is therefore generally possible to realize the shifting arrangement by means of only one single actuator drive, even if it can be advantageous in some embodiments for superordinate reasons to provide two shift shafts with a respective actuator motor.

The actuator motor is preferably an electric motor which can drive the shift shaft bidirectionally.

Furthermore, the shifting arrangement according to the invention makes it possible to carry out multiple shifting operations considerably more rapidly. Since the freewheel driver device ensures decoupling between the shift shaft and the rod, it is not necessary in the case of multiple downshifts to engage all intermediate gear stages, as is the case in a single shifting drum.

In addition, the shifting arrangement according to the invention can be realized using a small amount of installation space.

As a result of the arrangement of the shift shaft transversely with respect to the axially displaceable rod, the shifting arrangement can also be realized in gearboxes with two output shafts without or with relatively small bridging members (“linkages”).

The shifting arrangement preferably has a plurality of rods which are mounted such that they can be displaced axially parallel to one another in relation to the housing, and of which preferably half can be coupled to respective shifting clutch arrangements. In this case, the shift shaft can be coupled to the respective rods via a corresponding plurality of freewheel driver devices. In the case of a rotation of the shift shaft in the second rotational direction, it is therefore preferred if decoupling of all of the said rods from the shift shaft is realized. The means which are provided on the shift shaft for forming the freewheel driver devices are preferably arranged distributed over the circumference of the shift shaft, with the result that the freewheel driver devices come into action one after another in the case of a rotation of the shift shaft in the second rotational direction, the said freewheel driver devices ensuring the respective decoupling between the rod and the shift shaft.

The rods are preferably oriented next to one another in parallel in one plane.

In this embodiment, the features of the freewheel driver devices on the shift shaft are arranged offset axially in a corresponding way.

The shifting arrangement can be realized simply in terms of manufacturing and assembly technology, since it manages with few components and can be integrated comparatively simply into a gearbox housing.

The object is therefore achieved completely.

It is particularly preferred if the shift shaft can displace the rod exclusively in the first longitudinal direction by means of the driver device, with the result that the rod is configured as a push rod.

For this case, it is preferred if the shifting arrangement has a restoring device, by means of which the rod can be displaced in the opposed second longitudinal direction.

The restoring device can be realized in various ways, for example with the use of springs or the like.

According to one particularly preferred embodiment which represents an independent invention in conjunction with the features mentioned at the outset, the shifting arrangement has a further rod which is mounted axially displaceably in relation to the housing, the rod and the further rod being coupled to one another via a coupling device which is configured in such a way that the rod and the further rod can be displaced compulsorily in an opposed manner in the axial direction.

This embodiment makes it possible to configure the rod and the further rod in each case as a push rod which are coupled to the shift shaft by means of respective driver devices in such a way that they can be displaced in each case in the first longitudinal direction in the case of a rotation of the shift shaft in the first rotational direction. A displacement of the rod in the first longitudinal direction compulsorily leads to a displacement of the further rod in the second longitudinal direction on account of the coupling device, and vice versa.

It goes without saying that the driver devices are to be arranged on the shift shaft in such a way that simultaneous actuation of the rod and the further rod for the purpose of gear engagement is ruled out.

Whereas, in the prior art, what are known as shift rods are assigned in each case to a shifting clutch pack, that is to say as a rule to two gear stages, the present invention makes it possible to assign a dedicated rod functionally to each gear stage. On account of the coupling device which ensures the displaceability compulsorily in opposite directions, it is merely necessary here to couple one of the rods to the shifting clutch arrangement.

As has been mentioned, it is particularly preferable if the further rod is also coupled to the shift shaft via a further freewheel driver device.

In each case one pair of push rods which in each case comprise a rod and a further rod are preferably provided for each shifting clutch arrangement which is assigned to two gear stages of the motor vehicle gearbox.

According to a further overall preferred embodiment, the freewheel driver device has a shifting cam on the shift shaft and a cam follower section on the rod, the shifting cam acting on the cam follower section of the rod in the case of a rotation of the shift shaft in the first rotational direction, in order to move the said rod in the first longitudinal direction.

The cam follower section is preferably provided in an end region of the rod, which end region faces the shift shaft.

The freewheel function of the freewheel driver device can take place in various ways. Firstly, it is possible to provide a feature on the rod, which feature is provided for the freewheel property, and/or to provide a feature on the shift shaft, which feature contributes to the freewheel property.

Accordingly, it is preferred according to one embodiment if the cam follower section is mounted movably in relation to a base body of the rod, in such a way that the cam follower section can be moved away from the shifting cam in the case of a rotation of the shift shaft in the second rotational direction, without the rod being displaced in the axial direction.

As a consequence, the cam follower section is mounted movably in relation to the rod, in such a way that it can perform a yielding movement in the case of a movement of the shift shaft in the second rotational direction, with the result that the shifting cam preferably has no influence on the axial position of the rod.

According to a further preferred embodiment, the shifting cam is mounted movably on the shift shaft, in such a way that the shifting cam can be moved, in particular, away from the rod in the case of a rotation of the shift shaft in the second rotational direction, without the rod being displaced in the axial direction.

In the case of the movable cam follower section, it is preferred if it is configured so as to be pivotable in relation to the rod, the pivoting axis preferably running parallel to the shift shaft.

Furthermore, it is preferred here if the rod and its cam follower section are oriented within the gearbox in such a way that the cam follower section passes into a basic position on account of gravitational forces, in which basic position it is aligned with the rod, with the result that thrust forces can be transmitted from the shifting cam via the cam follower section to the rods if the shift shaft is rotated in the first rotational direction.

In the case of the movably mounted shifting cam, it is preferred if it is prestressed into a cam position by means of a spring, it being possible for the spring to be compressed by the shifting cam which acts on the rod in the case of a rotation of the shift shaft in the second rotational direction, with the result that the shifting cam can perform a yielding movement. The said yielding movement preferably takes place in the radial direction.

It can be provided in a further refinement that the cam is moved actively or passively depending on the rotational position of the shift shaft, in such a way that it passes reliably into the cam position again before a rotational movement in the first rotational direction is initiated, in which cam position the shifting cam can exert a thrust movement on the associated rod.

According to a further preferred embodiment, the shifting arrangement is designed to actuate gear stages of a double clutch gearbox, the double clutch gearbox having two component gearboxes, at least one neutral cam being configured on the shift shaft, which neutral cam is arranged in relation to a shifting cam of the shift shaft in such a way that, in the case of a rotation of the shift shaft in the first rotational direction in order to engage a gear stage of a component gearbox, it moves a rod which is assigned to another gear stage of the same component gearbox into a neutral position.

By way of this measure, an improvement in the shifting time can be achieved in the case of shifting operations in the same component gearbox. In particular, it is not necessary in the case of multiple shift operations to previously disengage a source gear stage by way of displacement of the rod which is assigned to the source gear stage by means of a shifting cam before a target gear stage is engaged in a component gearbox. Rather, in the case of an engagement operation of the target gear stage, in which a shifting cam moves the rod which is assigned to the target gear stage in the first longitudinal direction, the neutral cam can ensure that at least one gear stage of the same component gearbox is disengaged.

Here, the neutral cam can be configured to be radially shorter than the shifting cam, with the result that it “dives” under the rod in the case of the shifting movement after the neutral position of the rod has been reached, without moving the rod further in the shifting direction (first longitudinal direction). The neutral cam can also be so wide that it sweeps over both the gear shift rod and the shift rod which is coupled to it. Therefore, as soon as a neutral cam of this type reaches either the gear shift rod or the associated further shift rod in the case of the shifting rotational direction, both rods are pushed into the neutral position and the gear which has just been engaged in this way is disengaged. Since, in other words, the corresponding rods move towards one another in the case of simultaneous actuation by way of the neutral cam and (have to) meet in neutral, it is ensured that a gear cannot accidentally be engaged by way of the neutral cam.

As has already been mentioned above, it is advantageous if the shift shaft is driven by a single electric motor.

The shifting arrangement can therefore be realized inexpensively.

The rotational position of the shift shaft can be detected, for example, by way of an incremental sensor. It is preferred here if at least one referencing feature is provided on the shift shaft. In this case, the shift shaft can be moved in the second rotational direction, for example after a reset of a control unit, until the referencing feature is reached, as a result of which referencing can be carried out in a simple way, without it being necessary to compulsorily engage gear stages in between.

The referencing feature can be an electronic feature (Hall sensor or the like) or a mechanical feature.

According to a further preferred embodiment which represents an independent invention in conjunction with the features mentioned at the outset, the rod is configured as a push rod, the driver device having a shifting cam on the shift shaft, which shifting cam acts on an axial end side of the rod in the case of a rotation of the shift shaft in the first rotational direction.

This mechanical refinement makes a robust thrust actuation of the rod possible for the purpose of engaging a gear stage.

In one variant, the shifting cam can be mounted movably on the shift shaft here.

According to one preferred embodiment, the rod has, on a basic body, a shifting clutch actuating section and a section which can be pivoted in relation to the shifting clutch actuating section, the axial end side, on which the shifting cam can act, being configured on the pivotable section.

In this embodiment, the pivotable section forms the cam follower section for the shifting cam and makes it possible that the pivotable section can yield from the shifting cam in the case of a rotation of the shift shaft in the second rotational direction, with the result that a freewheel driver device can be realized in a structurally simple way.

In the case of a double clutch gearbox, either all gear stages can be operated by means of a single shift shaft, each gear stage preferably being assigned a dedicated rod in the form of a push rod. In this embodiment, the shift shaft can be realized by means of a single drive motor for shifting (in the first rotational direction) and for selecting (in the second rotational direction).

As an alternative, it is possible to provide two shift shafts which preferably operate in each case the gear stages of a component gearbox of a double clutch gearbox, the two shift shafts being driven by means of respective dedicated drive motors in this case.

The shift shaft preferably has a shifting cam for each push rod. The shift shaft is oriented in relation to the rod or the rods in such a way that an axis of the shift shaft is oriented transversely, in particular perpendicularly, with respect to the extent of the rod or the rods, in particular in a skewed manner with respect thereto.

In one preferred variant, a cam follower section of the rod is situated in the region of a circumscribed circle of the shifting cam of the shift shaft at least in a neutral position, with the result that the shifting cam can act on an axial end side of the rod, in order to move the said rod in the first longitudinal direction.

Furthermore, a park-by-wire function can be provided substantially without further additional outlay by means of an additional push rod pair. The number of gear stages of the motor vehicle gearbox preferably lies in a range from two to eight, in particular in a range from four to seven, plus in each case at least one reverse gear stage.

Under consideration of the shifting strategy, the arrangement of the shifting cams on the circumference of the shift shaft can be optimized in such a way that as few movements as possible (rotary angle) are required for selecting (movement in the second rotational direction).

Overall, improvements with regard to the shifting time and/or with regard to the installation space and/or with regard to the costs and/or with regard to the weight result with low outlay.

Each of the rods preferably has three longitudinal positions, namely a neutral position, a shifting position, in which a gear stage which is assigned functionally to the rod is engaged, and a non-shifting position, the neutral position lying between the shifting position and the non-shifting position. The coupling device between a rod and a further rod is preferably designed in such a way that, in one position, the coupling device holds both shift rods in the neutral position. The coupling devices can be provided with a latching means, if this is necessary.

Furthermore, the shift rods can be equipped in each case with latching means for the three positions.

It goes without saying that the features which are mentioned in the above text and are still to be explained in the following text can be used not only in the respectively specified combination, but rather also in other combinations or on their own, without departing from the scope of the present invention.

### BRIEF DESCRIPTION OF THE DRAWINGS

Exemplary embodiments of the invention are represented in the drawings and are explained in more detail in the following description. In the drawings:

FIG. 1 shows a diagrammatic illustration of a motor vehicle drive train with one embodiment of a shifting arrangement according to the invention,

FIG. 2 shows a sectional view along the line II-II in FIG. 1;

FIG. 3 shows a comparable illustration to FIG. 2, a shift shaft of the shifting arrangement performing a selecting movement;

FIG. 4 shows a comparable illustration to FIG. 3 of one variant of the shifting arrangement which is shown in FIGS. 1 to 3;

FIG. 5 shows a comparable illustration to FIG. 2 of a further embodiment of a shifting arrangement according to the invention;

FIG. 6 shows a comparable illustration to FIG. 3 of the shifting arrangement of FIG. 5;

FIG. 7 shows a comparable illustration to FIG. 6 of one variant of the shifting arrangement of FIGS. 5 and 6;

FIG. 8 shows a comparable illustration to FIG. 5 of the shifting arrangement of FIG. 7;

FIG. 9 shows a further diagrammatic plan view of a shifting arrangement according to a further embodiment of the invention;

FIG. 10 shows a sectional view along the line X-X of FIG. 9;

FIG. 11 shows a sectional view along the line XI-XI of FIG. 9; and

FIG. 12 shows a sectional view along the line XII-XII of FIG. 9.

### DESCRIPTION OF PREFERRED EMBODIMENTS

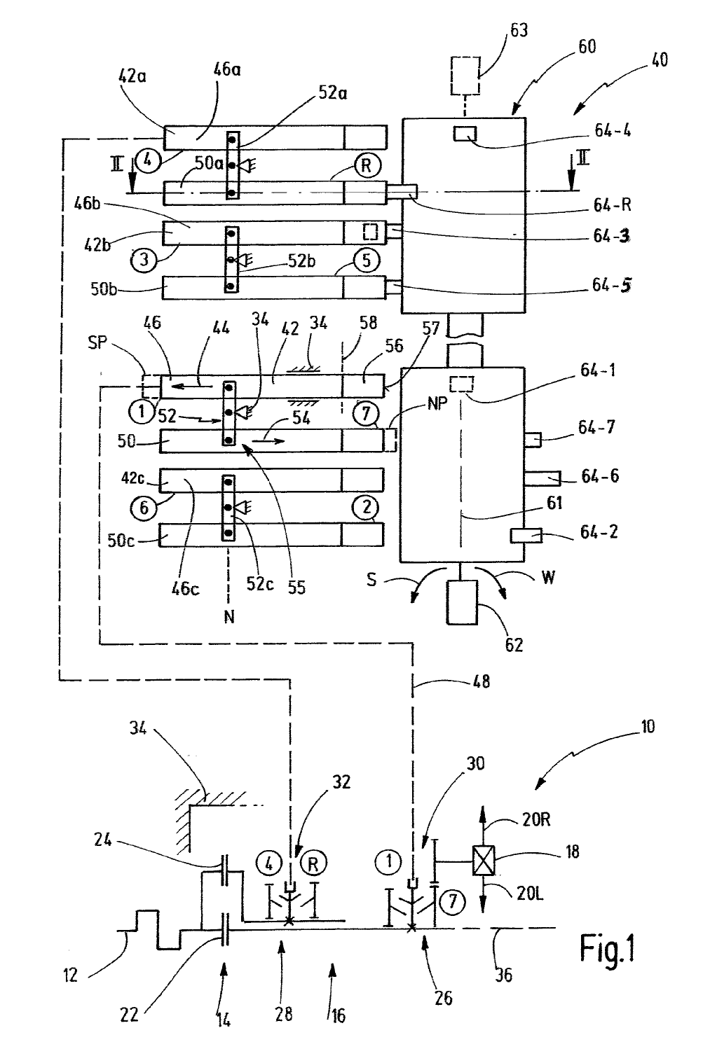

FIG. 1 diagrammatically shows a drive train for a motor vehicle, which drive train is denoted in general by 10. The drive train 10 comprises a drive motor 12, such as an internal combustion engine or a hybrid drive unit, a clutch arrangement 14, a motor vehicle gearbox 16 in the form of a multi-step gearbox and a differential 18, by means of which drive power can be distributed to driven wheels 20L, 20R.

Together with the clutch arrangement 14, the motor vehicle gearbox 16 is configured as a double clutch gearbox. The clutch arrangement 14 accordingly comprises a first friction clutch 22 for the odd gear stages and a second friction clutch 24 for the even gear stages of the gearbox 16. In a corresponding way, the gearbox 16 comprises a first component gearbox 26 for the odd gear stages and a second component gearbox 28 for the even gear stages.

For reasons of clarity, only some of the gear stages of the motor vehicle gearbox 16 are shown. The first component gearbox 26 comprises a first shifting clutch arrangement 30, by means of which, for example, the gear stages 1 and 7 can be shifted. Furthermore, the second component gearbox 28 comprises a second shifting clutch arrangement 32, by means of which, for example, the gear stages 4 and R can be shifted. It goes without saying that the first component gearbox 26 can have further gear stages 3, 5 and possibly 9, and the second component gearbox 28 can comprise further gear stages 2, 6 and possibly 8.

As shown, the motor vehicle gearbox 16 is configured as a multi-step gearbox of countershaft design, and the shifting clutch arrangements 30 in each case serve to connect idler gears which are assigned to the gear stages to a respective shaft. A common output of the two component gearboxes 26, 28 is connected to an input member of the differential 18.

Furthermore, FIG. 1 indicates that the drive train 10 can have a housing 34 which can be configured, in particular, as a gearbox housing. The drive train 10 defines a longitudinal axis 36, shafts of the gearbox 16, in particular, being arranged parallel to the said longitudinal axis 36.

The drive train 10 is, in particular, an automated drive train. The two friction clutches 22, 24 are thus preferably actuated in an automated manner, by means of suitable actuators which are not shown in FIG. 1, however. A shifting arrangement which is shown diagrammatically in FIG. 1 and is denoted by 40 is provided for actuating (that is to say, engaging and disengaging) gear stages of the gearbox 16.

The shifting arrangement 40 has a push rod 42 for the gear stage 1. The push rod 42 is mounted axially displaceably in relation to the housing 34. In FIG. 1, the push rod 42 is shown in a neutral position N and can be moved in a first longitudinal direction 44, as a result of which the gear stage 1 is engaged. For this purpose, the push rod 42 has a shifting clutch actuating section 46 which is coupled via a shifting clutch coupling 48 to the first shifting clutch arrangement 30.

The shifting arrangement 40 has a further push rod 50 which is assigned functionally to the gear stage 7, that is to say a gear stage which is assigned to the same shifting clutch arrangement 30 as the gear stage 1. The further push rod 50 is coupled via a coupling device 52 to the push rod 42 in such a way that the rod 42 and the further rod 50 can be displaced compulsorily in an opposed manner in the axial direction. Here, the coupling device 52 is configured, in particular, as a two-sided lever which has a lever pivot point which is fixed on the housing. As a consequence, a movement of the push rod 42 in the first longitudinal direction 44 compulsorily leads by means of the coupling device 52 to a movement of the further push rod 50 in a second longitudinal direction 54 which is opposed to the first longitudinal direction 44. As long as the push rod 42 is moved from the neutral position N which is shown using solid lines in FIG. 1 in the first longitudinal direction 44 into a shifting position SP, the further push rod 50 which is coupled via the coupling device 52 is moved in the second longitudinal direction 54 into a non-shifting position NP.

In order to move the push rod 42 into the neutral position N again, for example after engagement of the gear stage 1, in which the said push rod 42 is moved into the shifting position SP, the further push rod 50 is as a consequence to be moved in the first longitudinal direction 44, as a result of which the push rod 42 is moved by means of the coupling device 52 in the second longitudinal direction 54 in the direction of the neutral position N.

This embodiment forms a restoring device 55 for the push rod 42.

The push rod 42 for the gear stage 1 and the further rod 50 for the gear stage 7 form a push rod pair of the shifting arrangement 40. Further push rod pairs are provided for the other gear stages, namely a push rod 42a for the gear stage 4 and a further push rod 50a for the gear stage R, the push rods 42a, 50a being coupled to one another via a coupling device 52a. Furthermore, the shifting arrangement 40 comprises a push rod 42b for the gear stage 3 and a further push rod 50b for the gear stage 5 which are coupled to one another via a coupling device 52b. Finally, the shifting arrangement 40 comprises a push rod 42c for the gear stage 6 and a further push rod 50c for the gear stage 2 which are coupled to one another via a coupling device 52c. The method of operation of the respective push rod pairs is in each case identical. Each push rod pair is assigned to one of the two component gearboxes 26, 28 of the gearbox 16. The push rod pairs 42, 50 and 42b, 50b are assigned to the first component gearbox 26. The push rod pairs 42a, 50a and 42c, 50c are assigned to the second component gearbox 28.

The push rods comprise in each case one pivotable section 56 at their end which points in the second longitudinal direction 54. The pivotable section 56 has a cam follower section 57 on its axial end side and can be pivoted about a pivot axis 58 which is oriented transversely, in particular perpendicularly with respect to the longitudinal axis 36.

Furthermore, the shifting arrangement 40 comprises a shift shaft or camshaft 60 which has a shift shaft axis 61 which is likewise oriented transversely with respect to the longitudinal axis 36, in particular parallel to the pivot axes 58 of the pivotable sections 56 of the push rods 42, 50.

The shift shaft 60 can be driven bidirectionally by means of a single electric motor 62, to be precise either in a first rotational direction S (shifting direction) or a second rotational direction W (selecting direction).

As an alternative to this, the shift shaft 60 can be formed by two shift shaft sections which are driven in each case by means of dedicated electric motors, which is indicated in FIG. 1 by way of a second electric motor 63.

The push rods 42, 50 are arranged in a common plane which is oriented parallel to the shift shaft axis 61, in particular offset in parallel with respect thereto.

A plurality of shifting cams 64 are configured on the shift shaft 60, which shifting cams 64 are assigned in each case to one of the push rods 42, 50 or one of the gear stages of the multi-step gearbox. In other words, the shifting cams 64 which are provided with a suffix in FIG. 1 which corresponds to the gear stage to which they are assigned in each case, are arranged distributed along the shift shaft axis 61 in such a way that they are aligned in each case with the longitudinal extent of the push rod 42 or 50 which is assigned to them.

Furthermore, the shifting cams 64 are arranged distributed over the circumference of the shift shaft 60. In the plan view which is shown in FIG. 1, the shifting cam 64-4 is oriented upwards, for example, and the shifting cam 64-1 is oriented downwards, for example. Furthermore, FIG. 1 diagrammatically indicates that the shifting cam 64-R bears against the cam follower section 57 of the further push rod 50a for the reverse gear stage R. The shifting cam 64-5 is directed obliquely downwards, and the shifting cam 64-3 is arranged below the associated push rod 42b in the illustration in FIG. 1.

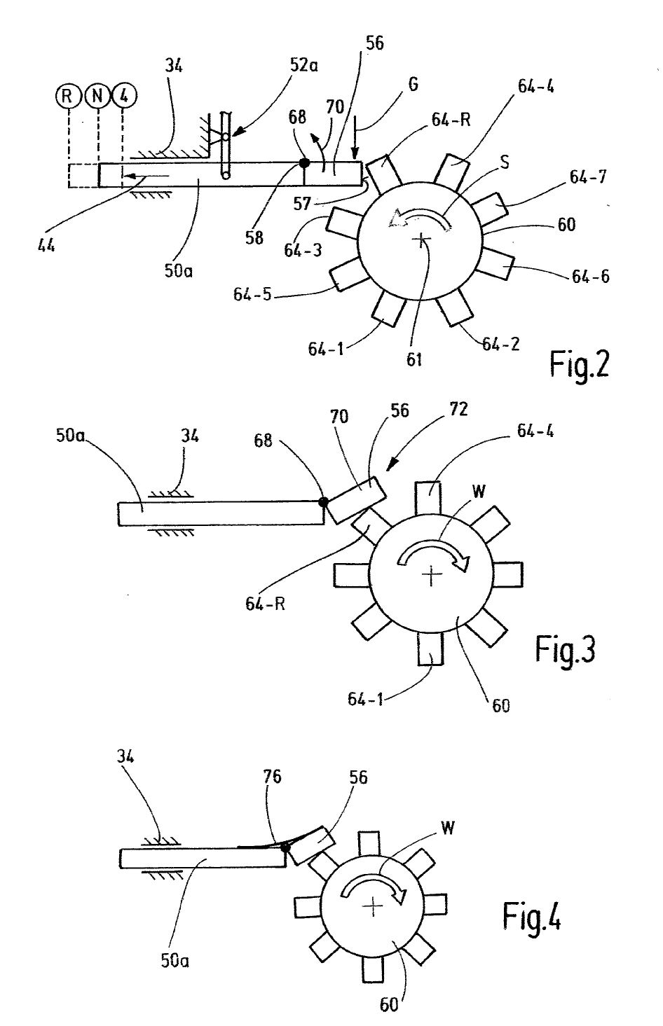

The pivotable sections 56 of the push rods 42, 50 are articulated pivotably in each case via a diagrammatically indicated hinge 68 or the like (FIG. 2) such that they can be pivoted on a basic body of the respective push rod 42, 50. Here, the hinge 68 is configured in such a way that, depending on the installation position in the multi-step gearbox 16, it ensures that the pivotable section 56 is generally in a position on account of gravitational forces G, in which position it is aligned with the basic body of the respective push rod 42, 50, as shown in FIG. 2. Instead of or in addition to the gravitational forces G, springs can be provided, in order to move the pivotable section 56 into the basic position which is shown in FIG. 2.

In the said basic position, the pivotable section 56 bears against the basic body of the respective shift rod 42, 50 in such a way that axial forces which are exerted on the pivotable section 56 (more precisely, its cam follower section 57) can be transmitted in the direction of the first longitudinal direction 44 to the basic body of the respective shift rod 42, 50. FIG. 2 shows a position, in which the shifting cam 64-R is situated in a rotational position, in which it bears against the cam follower section 57 of the push rod 50a for the reverse gear stage R. A rotation of the shift shaft 60 in the shifting direction S then leads to an axial movement of the push rod 50a in the first longitudinal direction 44, in order in this way to engage the reverse gear stage R from the neutral position N which is shown in FIG. 2.

Beforehand, the push rod 50a of the reverse gear stage R has been selected as that push rod which corresponds to a target gear stage (reverse gear stage here). This has taken place by way of a selecting operation, in which the shift shaft 60 has been rotated in a second rotational direction W (selecting direction), as shown in FIG. 3. Here, the shift shaft 60 has been rotated until the shifting cam 64-R was situated on the side of the cam follower section 57 of the push rod 50a.

On the way into the said position, contact of the shifting cam 64-R with the underside of the pivotable section 56 of the associated push rod (shown as 50a by way of example in FIG. 3) has occurred during rotation of the shift shaft 60 in the second rotational direction. More precisely, FIG. 3 shows a state, in which the shifting cam 64-R has acted on the underside of the pivotable section 56 of the push rod 50a on account of the selecting movement W, as a result of which the pivotable section 56 has performed a yielding movement which is shown at 70 in FIG. 3. As a result of this deflection or yielding movement 70, the contact of the shifting cam 64-R has no influence here on the axial position of the associated push rod 50a. The rotational direction of the shift shaft 60 can be reversed only when the shifting cam 64-R is situated in the position which is shown in FIG. 2, in order to exert a thrust force in the first longitudinal direction 44 on the push rod 50a.

It can also occur during the selecting operation, depending on how far away from the target push rod the target shifting cam is, that the shifting cams of other gear stages have deflected the pivotable sections of their associated push rod, as shown diagrammatically in FIG. 3.

After the respective gear stage has been engaged (position R of the further push rod 50a in FIG. 2), the said gear stage remains engaged until a thrust movement is exerted by means of the shifting cam 64-4 on the coupled push rod 42a, to be precise by means of the shifting cam 64-4. Starting from the position which is shown in FIG. 2, the shift shaft 60 is to be rotated in the selecting direction W here until the shifting cam 64-4 is situated in the position which is assigned to the shifting cam 64-R in FIG. 2.

On account of the fact that, after the engagement of a gear stage (by way of example, gear stage R in FIG. 2), the said gear stage remains engaged when a selecting operation takes place, a further gear stage can be engaged, for example, in the other component gearbox, for example the gear stage 1, by the shift shaft 60 first of all being moved in the selecting direction until the shifting cam 64-1 is situated in the position which is assigned to the shifting cam 64-R in FIG. 2. Subsequently, the shift shaft can be moved in the shifting direction S, in order to move the push rod 42 out of the neutral position which is shown in FIG. 1 into the shifting position SP which is assigned to the gear stage 1.

On account of the fact that the shifting cams are arranged distributed over the circumference, it is possible to move in each case only one push rod in the first longitudinal direction 44 in a targeted manner, the other push rods remaining unmoved during the transition of one push rod from the neutral position N into the shifting position SP.

In the embodiments which are shown above in relation to FIGS. 1 to 3, the shifting cams 64 and the pivotable sections 56 in each case together form a freewheel driver device 72 which is distinguished by the fact that a push rod is driven in a first longitudinal direction 44 in the case of a rotation of the shift shaft 60 in the shifting direction S, whereas decoupling of the rods from the shift shaft 60 takes place in the case of a rotation of the shift shaft in the selecting direction W.

Although the above-described shifting arrangement 40 is designed for a double clutch gearbox with two component gearboxes 26, 28, it goes without saying that the method of operation of the shifting arrangement 40 can be applied in the same way to an automated change-speed gearbox, the clutch arrangement of which has only a single friction clutch and which is formed by a single gearbox of countershaft design which can have a plurality of forward gear stages and one reverse gear stage. It is likewise possible by way of the shifting arrangement 40 to actuate an existing parking lock. It goes without saying here that the required shifting clutch coupling can differ here from the shifting clutch coupling 48 which is shown.

In general, however, the shifting arrangement can also be applied to different types of motor-vehicle gearboxes, for example to converter automatic gearboxes or to other multi-step gearboxes.

In the following text, further embodiments of shifting arrangements for motor vehicles will be described which correspond generally to the embodiment of FIGS. 1 to 3 with regard to the construction and method of operation. Identical elements are therefore labelled by identical reference numerals. Essentially the differences will be explained in the following text.

FIG. 4 shows an illustration which corresponds to FIG. 3, in which the pivotable section 56 is pivoted with respect to a basic body of a push rod 50a. Here, the push rod 50a is assigned a spring device 76, for example in the form of a leaf spring 76, which ensures that the pivotable section 56 is guided reliably back into the basic position again which is shown in FIG. 2 after pivoting out of its starting position. The spring device 76 can be designed in such a way that it acts in addition to the gravitational forces G, or instead of them or counter to them.

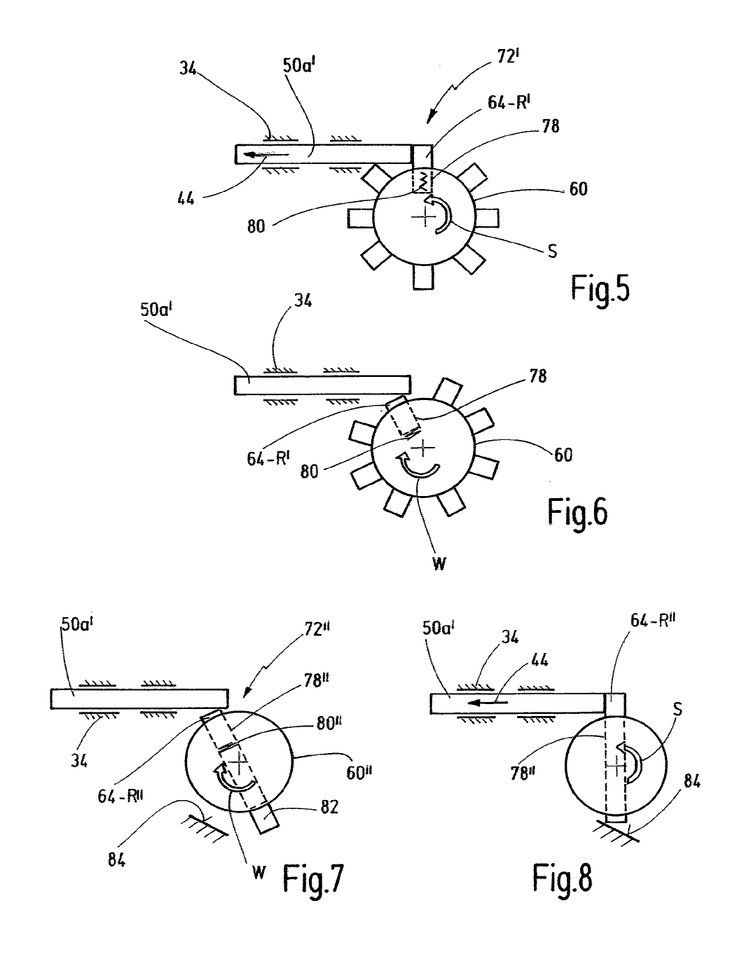

In the embodiments which are shown in FIGS. 5 to 8, a freewheel driver device is formed in each case by virtue of the fact that a shifting cam is mounted radially movably on the shift shaft, in order for it to be possible to move the shifting cam in the case of a rotation of the shift shaft in the second rotational direction, without displacing the associated rod in the axial direction.

A first variant is shown in FIGS. 5 and 6.

Here, each shifting cam (the shifting cam 64-R′ by way of example in FIGS. 5 and 6) is assigned a recess 78 in the shift shaft 60. The shifting cams 64 are pressed radially out of the recesses 78 via respective compression springs 80, to be precise into the basic position which is shown in FIG. 5, in which they can exert a thrust force on an associated push rod 50a′.

In this embodiment, the push rods can be configured in one piece in each case, that is to say without a pivotable section 56 as in the embodiments of FIGS. 1 to 4.

FIG. 5 shows here that a shifting cam 64-R′ of a freewheel driver device 72′ can exert a thrust force on the push rod 50a′, in order to move the latter in the first longitudinal direction 44. FIG. 6 shows the corresponding selecting operation, in which the shift shaft 60 is rotated in the second rotational direction W. It is shown here that the shifting cam 64-R′ is pressed from the underside of the push rod 50a′ radially inwards into the recess 78 in the case of the selecting movement W, in order to achieve the freewheel property.

An alternative embodiment is shown in FIGS. 7 and 8. Here, a freewheel driver device 72″ likewise comprises a shifting cam 64-R″ which can be pressed radially into a recess 78″. In this variant, however, the shifting cam 64-R″ extends in the radial direction through the shift shaft 60″ and forms a restoring cam 82 on the opposite side.

During a selecting movement, as shown in FIG. 7, the restoring cam 82 comes into contact with a restoring ramp 84, in order to be pressed radially out of the recess 78″ after the shifting cam 64-R″ dives through below the push rod 50a′, on account of the positively locking connection between the restoring cam 82 and the restoring ramp 84. FIG. 8 shows this state, starting from which a shifting movement S can once again be initiated, in order to axially move the push rod 50a′ in the first longitudinal direction 44.

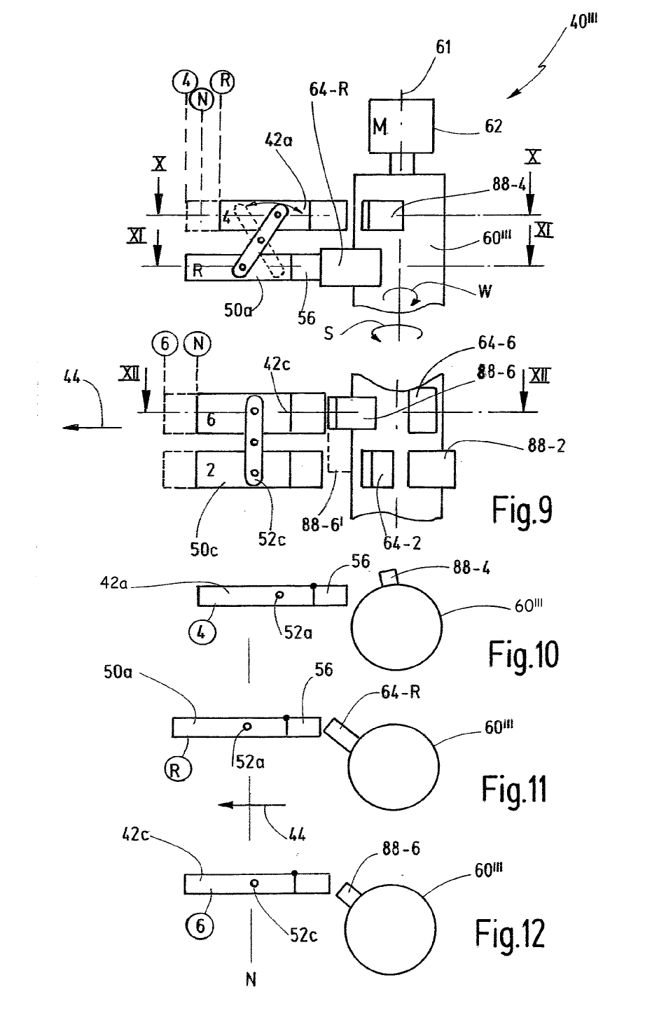

FIGS. 9 to 12 show a further embodiment of a shifting arrangement 40′″ which corresponds in general to the shifting arrangement 40 of FIGS. 1 to 3 with regard to construction and method of operation.

Here, respective neutral cams 88 are configured on the shift shaft 60′″ in a manner which is assigned to the respective shifting cams 64. The neutral cams 88 are oriented with their respective shifting cam 64 in the circumferential direction and have a smaller radial length than the shifting cam 64.

A neutral cam 88 which is aligned with a shifting cam in the circumferential direction is designed to move at least one push rod of a gear stage of the same component gearbox into a neutral position in the case of a thrust movement being carried out on a push rod which is assigned to the shifting cam.

This is explained in FIGS. 9 to 12 using the following example. In FIGS. 9 to 12, a shifting cam 64-R is situated in contact with a push rod 50a, in a similar manner to the starting position, as shown in FIG. 2. The push rod 50a serves to engage the reverse gear stage R. In the case of a movement of the shift shaft 60′″ in the shifting direction S, the push rod 50a is moved in the first longitudinal direction, in exactly the same way as in the embodiment of FIGS. 1 to 3.

Here, the neutral cam 88-6 which is assigned to the shifting cam 64-R is aligned axially with the push rod 42c which is assigned to a gear stage (gear stage 6) which is seated on the same component gearbox as the target gear stage R.

During the shifting movement, the neutral cam 88-6 can move the push rod 42c, starting from a non-shifting position (cf. NP in FIG. 1), into the neutral position N. Here, the radial length of the neutral cam 88 is selected in such a way that it can displace the associated push rod 42c in the first longitudinal direction 44 until the push rod 42c is situated in the neutral position which is shown in FIG. 12. During this movement or immediately following this rotational movement of the shift shaft 60′″, the push rod 50a which is assigned to the shifting cam 64-R is then moved out of the neutral position into the shifting position SP (cf. FIG. 1) which corresponds to an engaged reverse gear stage R.

Here, the neutral cam which is assigned to a shifting cam can move a gear stage of the component gearbox of the target gear stage into the neutral position. The neutral cam 88 is preferably configured in such a way and has such an axial length (as viewed in the direction of the longitudinal direction 61 of the shift shaft 60″′) that it can move all other gear stages of that component gearbox into the neutral position, apart from that gear stage which is assigned to the push rod which is coupled to the target push rod via a coupling device 52. In the example of FIG. 9, the neutral cam 88-6 could extend as a consequence over such an axial length (shown at 88-6′), that it can move not only the push rod 42c of the gear stage 6 into the neutral position, but rather also the push rod 50c which is assigned to the gear stage 2 of that component gearbox. Secondly, the neutral cam 88-6′ does not extend to an axial position, in which it would move the push rod 42a, since the push rod 42a is moved by means of the coupling device into the non-shifting position NP in the case of the movement of the push rod 50a into the shifting position SP (R), as shown in FIG. 9.

In the present case, the neutral cam serves as a consequence, in the case of a rotation of the shift shaft in the first rotational direction in order to engage a gear stage of a component gearbox, to move a rod which is assigned to another gear stage of the same component gearbox into a neutral position.

A concept of this type can also be applied to a shifting arrangement which is designed for actuating a motor vehicle gearbox in the form of an automated change-speed gearbox. In this case, the neutral cam can be configured to move all other push rods into a neutral position, apart from the push rod which is assigned to the shifting cam which is assigned to the neutral cam, and apart from that push rod which is coupled to that push rod via a coupling device.

Overall, an electric-motor shifting actuation means, in particular for double clutch gearboxes, can be provided by way of the present invention, it being possible for short shifting times, free shifting sequences and low package requirements to be realized, to be precise preferably with the use of only one drive motor or shifting motor and preferably with a construction which is simple in terms of manufacturing and assembly technology.

1. A Shifting arrangement for a motor vehicle gearbox, having a housing which defines a longitudinal axis, having a rod which is mounted axially displaceably in relation to the housing and which can be coupled to a shifting clutch arrangement, and having a shift shaft which is mounted rotatably in relation to the housing and which is oriented transversely with respect to the longitudinal axis, the shift shaft being coupled to the rod by means of a driver device in such a way that the rod is displaced in a first longitudinal direction in the case of a rotation of the shift shaft in a first rotational direction;
wherein the driver device is a freewheel driver device which is configured in such a way that the rod is decoupled from the shift shaft in the case of a rotation of the shift shaft in a second rotational direction.

2. The shifting arrangement according to claim 1, comprising a restoring device, by means of which the rod can be displaced in a second longitudinal direction.

3. The shifting arrangement according to claim 1, wherein the shifting arrangement has a further rod which is mounted axially displaceably in relation to the housing, the rod and the further rod being coupled to one another via a coupling device which is configured in such a way that the rod and the further rod can be displaced compulsorily in an opposed manner in the axial direction.

4. The shifting arrangement according to claim 3, wherein the further rod is coupled to the shift shaft via a further freewheel driver device.

5. The shifting arrangement according to claim 1, wherein the freewheel driver device has a shifting cam on the shift shaft and a cam follower section on the rod, the shifting cam acting on the cam follower section of the rod in the case of a rotation of the shift shaft in the first rotational direction, in order to move the said rod in the first longitudinal direction.

6. The shifting arrangement according to claim 5, wherein the cam follower section is mounted movably in relation to the rod, in such a way that the cam follower section can be moved away from the shifting cam in the case of a rotation of the shift shaft in the second rotational direction, without the rod being displaced in the axial direction.

7. The shifting arrangement according to claim 5, wherein the shifting cam is mounted movably on the shift shaft, in such a way that the shifting cam can be moved in the case of a rotation of the shift shaft in the second rotational direction, without the rod being displaced in the axial direction.

8. The shifting arrangement according to claim 1, wherein the shifting arrangement is designed to actuate gear stages of a double clutch gearbox which has two component gearboxes, at least one neutral cam being configured on the shift shaft, which neutral cam is arranged in relation to a shifting cam of the shift shaft in such a way that, in the case of a rotation of the shift shaft in the first rotational direction in order to engage a gear stage of a component gearbox, it moves a rod which is assigned to another gear stage of the same component gearbox into a neutral position.

9. The shifting arrangement according to claim 1, wherein the shift shaft is driven by a single electric motor.

10. The shifting arrangement according to claim 1, wherein the rod is configured as a push rod, the driver device having a shifting cam on the shift shaft, which shifting cam acts on an axial end side of the rod in the case of a rotation of the shift shaft in the first rotational direction.

11. The shifting arrangement according to claim 10, wherein the rod has a shifting clutch actuating section and a pivotable section which can be pivoted in relation to the shifting clutch actuating section, the axial end side, on which the shifting cam can act, being configured on the pivotable section.

12. A shifting arrangement for a motor vehicle gearbox, having a housing which defines a longitudinal axis, having a rod which is mounted axially displaceably in relation to the housing and which can be coupled to a shifting clutch arrangement, and having a shift shaft which is mounted rotatably in relation to the housing and which is oriented transversely with respect to the longitudinal axis, the shift shaft being coupled to the rod by means of a driver device in such a way that the rod is displaced in a first longitudinal direction in the case of a rotation of the shift shaft in a first rotational direction;
wherein the shifting arrangement has a further rod which is mounted axially displaceably in relation to the housing, the rod and the further rod being coupled to one another via a coupling device which is configured in such a way that the rod and the further rod can be displaced compulsorily in an opposed manner in the axial direction.

13. The shifting arrangement according to claim 12, wherein the further rod is coupled to the shift shaft via a further freewheel driver device.

14. The shifting arrangement according to claim 12, wherein the freewheel driver device has a shifting cam on the shift shaft and a cam follower section on the rod, the shifting cam acting on the cam follower section of the rod in the case of a rotation of the shift shaft in the first rotational direction, in order to move the rod in the first longitudinal direction.

15. The shifting arrangement according to claim 14, wherein the cam follower section is mounted movably in relation to the rod, in such a way that the cam follower section can be moved away from the shifting cam in the case of a rotation of the shift shaft in the second rotational direction, without the rod being displaced in the axial direction.

16. The shifting arrangement according to claim 14, wherein the shifting cam is mounted movably on the shift shaft, in such a way that the shifting cam can be moved in the case of a rotation of the shift shaft in the second rotational direction, without the rod being displaced in the axial direction.

17. The shifting arrangement according to claim 12, wherein the shifting arrangement is designed to actuate gear stages of a double clutch gearbox which has two component gearboxes, at least one neutral cam being configured on the shift shaft, which neutral cam is arranged in relation to a shifting cam of the shift shaft in such a way that, in the case of a rotation of the shift shaft in the first rotational direction in order to engage a gear stage of a component gearbox, it moves a rod which is assigned to another gear stage of the same component gearbox into a neutral position.

18. The shifting arrangement according to claim 12, wherein the rod is configured as a push rod, the driver device having a shifting cam on the shift shaft, which shifting cam acts on an axial end side of the rod in the case of a rotation of the shift shaft in the first rotational direction.

19. The shifting arrangement according to claim 18, wherein the rod has a shifting clutch actuating section and a pivotable section which can be pivoted in relation to the shifting clutch actuating section, the axial end side, on which the shifting cam can act, being configured on the pivotable section.

20. A shifting arrangement for a motor vehicle gearbox, having a housing which defines a longitudinal axis, having a rod which is mounted axially displaceably in relation to the housing and which can be coupled to a shifting clutch arrangement, and having a shift shaft which is mounted rotatably in relation to the housing and which is oriented transversely with respect to the longitudinal axis, the shift shaft being coupled to the rod by means of a driver device in such a way that the rod is displaced in a first longitudinal direction in the case of a rotation of the shift shaft in a first rotational direction;
wherein that the rod is configured as a push rod, the driver device having a shifting cam on the shift shaft, which shifting cam acts on an axial end side of the rod in the case of a rotation of the shift shaft in the first rotational direction.

21. The shifting arrangement according to claim 20, wherein the rod has a shifting clutch actuating section and a pivotable section which can be pivoted in relation to the shifting clutch actuating section, the axial end side, on which the shifting cam can act, being configured on the pivotable section.

22. A method for actuating a shifting clutch arrangement of a motor vehicle gearbox, the shifting clutch arrangement being coupled to an axially displaceable rod, it being possible for a shift shaft which is oriented transversely with respect to the rod to be driven in a first and in a second rotational direction by means of a drive motor, and a shifting cam being configured on the shift shaft, having the steps:
selection of the shifting clutch arrangement by way of rotation of the shift shaft in the second rotational direction, without the rod being moved axially in the process; and
shifting of the shifting clutch arrangement, by the shift shaft being rotated in the first rotational direction, the shifting cam displacing the rod in the axial direction, in order to engage a gear stage of the shifting clutch arrangement.
